(19) United States
(12) Patent Application Publication
(10) Pub. No.: US 2009/0166495 A1
(43) Pub. Date: Jul. 2, 2009

(54) ELECTRICALLY CONTROLLED ROTATABLE FLAT PANEL DISPLAY BRACKET

(76) Inventor: Chin-Jui HUNG, Taichung Hsien (TW)

Correspondence Address: Rabin & Berdo, P.C., Suite 500, 1101 14th Street, Washington, DC, 20005, US

(21) Appl. No.: 11/964,170

(22) Filed: Dec. 26, 2007

(51) Int. Cl. A47F 5/00; G06F 1/16

(52) U.S. Cl. 248/289.11

(57) ABSTRACT

An electrically controlled rotatable flat panel display bracket has a rotatable base, a frame, a control module, a driving device and a display rack. The rotatable base has a rotating disc, a stationary disc and a bearing. The bearing is mounted between the rotating disc and the stationary disc. The frame is attached to the rotating disc. The driving device is controlled by the control module and connected between the stationary and rotating discs to rotate the rotating disc relative to the stationary disc. The display rack is mounted on the frame for hanging a flat panel display easily.

### BACKGROUND OF THE INVENTION

1. Field of Invention

The present invention relates to a flat panel display bracket, and more particularly to a rotatable flat panel display bracket.

2. Description of the Related Art

Flat Panel Displays (FPD) are thin and lightweight. Normally, the FPD is hung on a wall or placed on a television cabinet in a living room. However, because the FPD is hung or attached to a surface, changing a viewing angle is not achieved easily.

The present invention provides an electrically controlled rotatable flat panel display bracket to obviate or mitigate the shortcomings of the conventional setting methods of the FPD.

### SUMMARY OF THE INVENTION

The primary objective of the present invention is to provide an electrical controlled rotatable flat panel display bracket allowing a flat panel display (FPD) to be rotated conveniently.

The electrically controlled rotatable flat panel display bracket has a rotatable base, a frame, a control module, a driving device and a display rack. The rotatable base has a rotating disc, a stationary disc and a bearing. The bearing is mounted between the rotating disc and the stationary disc. The frame is attached to the rotating disc. The driving device is controlled by the control module and connected between the stationary and rotating discs to rotate the rotating disc relative to the stationary disc. The display rack is mounted on the frame for attaching a flat panel display.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an electrically controlled rotatable flat panel display bracket in accordance with the present invention;

FIG. 2 is an enlarged, operational perspective view in partial section of a driving device of the rotatable flat panel display bracket in FIG. 1, shown extended;

FIG. 3 is an enlarged, operational perspective view in partial section of the driving device of the rotatable flat panel display bracket in FIG. 1, shown retracted;

FIG. 4 is a perspective view of the electrical controlled rotatable flat panel display bracket in FIG. 1, shown mounting a flat panel display;

FIG. 5 is an operational top view of the electrical controlled rotatable flat panel display bracket in FIG. 4, showing internal elements and the flat panel display being shown in phantom lines; and

FIG. 6 is an operational top view of the electrical controlled rotatable flat panel display bracket in FIG. 5, shown rotating.

### DETAILED DESCRIPTION OF THE INVENTION

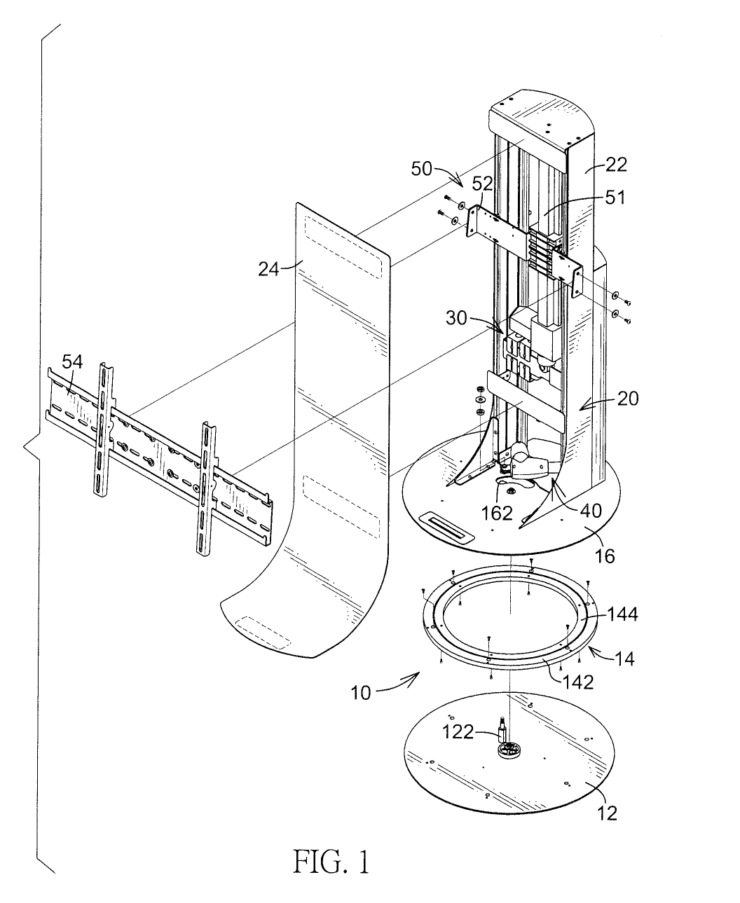

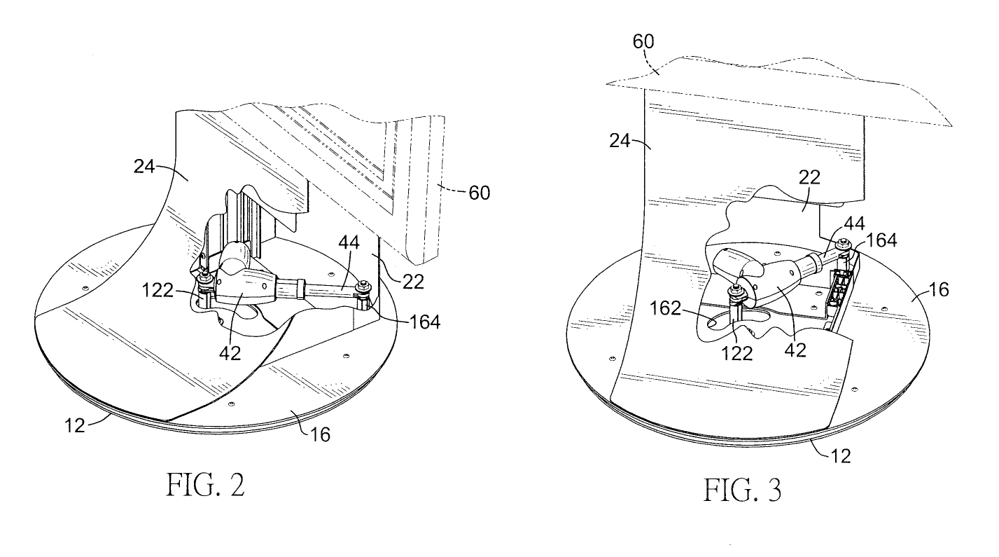

With reference to FIGS. 1, 2, and 3, an electrically controlled rotatable flat panel display bracket in accordance with the present invention comprises a rotatable base (10), a frame (20), a control module (30), a driving device (40) and an optional display rack (50).

The rotatable base (10) has a rotating disc (16), a stationary disc (12) and may have a bearing (14).

The rotating disc (16) has a top surface, a bottom surface, a slot (162) and a fixing bar (164). The slot (162) is formed through the top surface of the rotating disc (16) and may be arced. The fixing bar (164) protrudes from the top surface of the rotating disc (16).

The stationary disc (12) corresponds to the rotating disc (16), is rotatably mounted coaxially on the bottom surface of the rotating disc (16) and has a top surface and a holding bar (122). The holding bar (122) protrudes from the top surface of the stationary disc (12) and has a distal end being mounted through the slot (162).

The bearing (14) is coaxially mounted between the rotating disc (16) and the stationary disc (12) and may comprise an outer ring (142) and an inner ring (144) being securely mounted respectively to the stationary and rotating discs (12)(16). The inner ring (144) is rotatably mounted inside the outer ring (142).

The frame (20) is attached securely to the rotating disc (16) of the rotatable base (10) and has a body (22) and an optional cover (24). The body (22) may be tubular and has a proximal end, a distal end, a front surface, an inner surface and an opening. The proximal end is formed on the top surface of the rotating disc (16). The opening is formed on the front surface of the body (22).

The cover (24) corresponds to the opening of the body (22), detachably covers the opening of the body (22) and has two longitudinal edges. The longitudinal edges form guide slots (242) with the body (22) when the cover (24) covers the opening of the body (22).

The control module (30) is an electronic module for controlling connected mechanical apparatuses, may be remote controllable, may comprise a control panel and may be mounted on the inner surface of the body (22).

The driving device (40) has a controllably changeable length, is electronically connected to the control module (30), is controlled by the control module (30) to change the length, may be a motor-controlled robot, an electronic cylinder or the like and has a driving device body (42) and an extending arm (44). The driving device body (42) is pivotally mounted on the holding bar (122). The extending arm (44) is telescopically mounted on the driving device body (42) and pivotally mounted on the fixing bar (164) and is controlled by the control module (30) to move away or toward the proximal end to rotate the rotating disc (16) on the stationary disc (12) coaxially when the holding bar (122) moves along the slot (162). When the driving device (40) is the motor-controlled robot, the driving device body (42) is a motor being controlled by the control module (30) to actuate the extending arm (44) to move toward or away the motor.

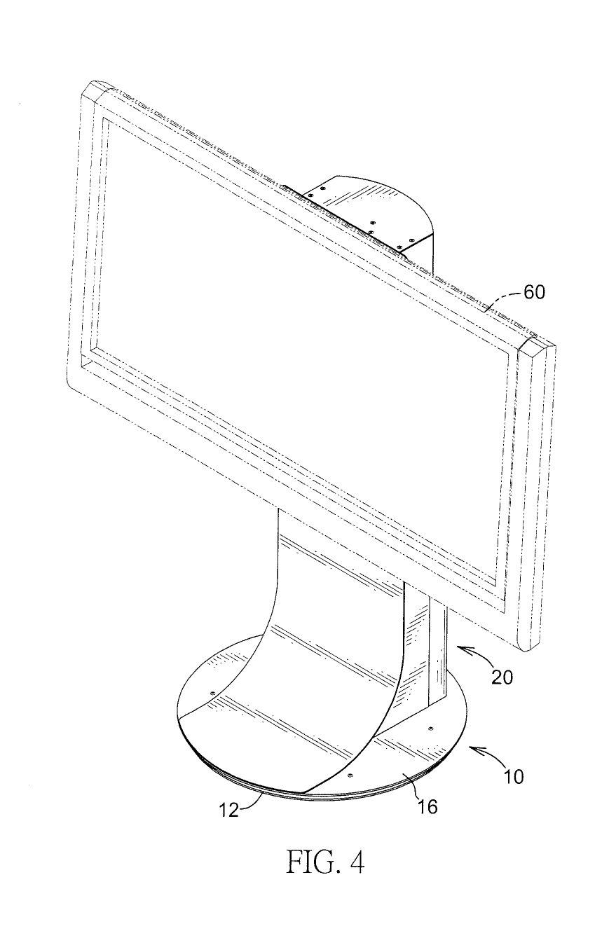

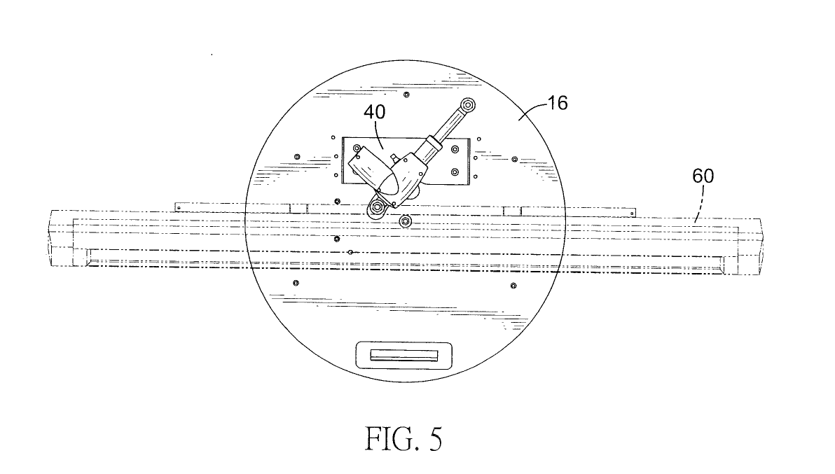

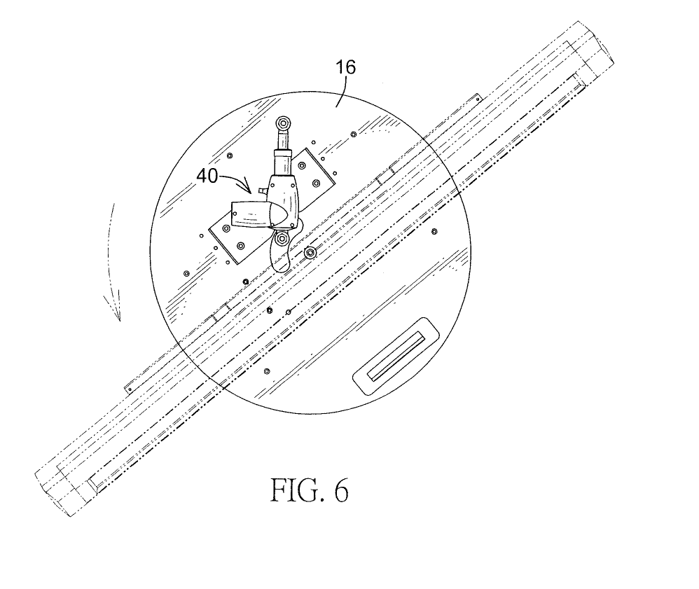

With further reference to FIGS. 4, 5 and 6, the display rack (50) has a rail (51), a sliding bracket (52) and at least one display bracket (54). The rail (51) is attached longitudinally to the inner surface of the body (22). The sliding bracket (52) is slidably mounted on the rail (51) and protrudes through the guiding slots formed between the cover (24) and the body (22). The display bracket (54) is attached to the sliding bracket (52) and may be mounted securely on a flat panel display (FPD) (60).

A remote control, or the control panel may be used by a person to actuate the control module (20) to rotate the rotating disc (16) and the frame (20) around the stationary disc (16) to adjust a viewing angle of the FPD (60) easily and automatically.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An electrically controlled rotatable flat panel display bracket comprising:
a rotatable base having
a rotating disc having
a top surface;
a bottom surface;
a slot being formed through the top surface of the rotating disc; and
a fixing bar protruding from the top surface of the rotating disc;
a stationary disc corresponding to the rotating disc, being rotatably mounted coaxially on the bottom surface of the rotating disc and having
a top surface; and
a holding bar protruding from the top surface of the stationary disc and having a distal end being mounted through the slot;
a frame being attached to the rotating disc of the rotatable base and having a body having
a proximal end being formed on the top surface of the rotating disc;
a distal end;
a front surface;
an inner surface; and
an opening being formed on the front surface of the body;
a control module being an electronic module; and
a driving device having a controllably changeable length, being controlled by the control module to change the length and having
a driving device body being pivotally mounted on the holding bar; and
an extending arm being telescopically mounted on the driving device body, pivotally mounted on the fixing bar and being controlled by the control module to move away or toward the proximal end of the driving device body.

2. The electrically controlled rotatable flat panel display bracket as claimed in claim 1, wherein the frame further has a cover corresponding to and detachably covering the opening of the body and having two longitudinal edges.

3. The electrically controlled rotatable flat panel display bracket as claimed in claim 2, wherein
the longitudinal edges of the cover form guide slots with the body when the cover covers the opening of the body; and
the electrically controlled rotatable flat panel display bracket further has a display rack having
a rail being attached longitudinally to the inner surface of the body;
a sliding bracket being slidably mounted on the rail and protruding through the guide slots; and
at least one display bracket being attached to the sliding bracket.

4. The electrically controlled rotatable flat panel display bracket as claimed in claim 1, wherein the rotatable base further has a bearing being coaxially mounted between the rotating disc and the stationary disc.

5. The electrically controlled rotatable flat panel display bracket as claimed in claim 1, wherein the slot is arced.

6. The electrical controlled rotatable flat panel display bracket as claimed in claim 3, wherein the rotatable base further has a bearing being coaxially mounted between the rotating disc and the stationary disc.

7. The electrically controlled rotatable flat panel display bracket as claimed in claim 6, wherein the bearing has
an outer ring being mounted on the bottom surface of the rotating disc; and
an inner ring being rotatably mounted inside the outer ring and being mounted on the top surface of the stationary disc.

8. The electrically controlled rotatable flat panel display bracket as claimed in claim 7, wherein the control module is remote controllable.

9. A rotatable base for an electrically controlled rotatable flat panel display bracket comprising
a rotating disc having
a top surface;
a bottom surface;
a slot being formed through the top surface of the rotating disc; and
a fixing bar protruding from the top surface of the rotating disc;
a stationary disc corresponding to the rotating disc, being rotatably mounted coaxially on the bottom surface of the rotating disc and having
a top surface; and
a holding bar protruding from the top surface of the stationary disc and having a distal end protruding through the slot;
a control module being an electronic module; and
a driving device having a controllably changeable length, being controlled by the control module to change the length and having
a driving device body being pivotally mounted on the holding bar; and
an extending arm being telescopically mounted on the driving device body, pivotally mounted on the fixing bar and being controlled by the control module to move away or toward the proximal end of the driving device body.

10. The rotatable base for an electrically controlled rotatable flat panel display bracket as claimed in claim 9, wherein the rotatable base has a bearing being coaxially mounted between the rotating disc and the stationary disc.

11. The rotatable base for an electrically controlled rotatable flat panel display bracket as claimed in claim 10, wherein the bearing has
an outer ring being mounted on the bottom surface of the rotating disc; and
an inner ring being rotatably mounted in the outer ring and being mounted on the top surface of the stationary disc.

12. The rotatable base for an electrically controlled rotatable flat panel display bracket as claimed in claim 10, wherein the slot is arced.
